(19) United States
(12) Patent Application Publication
(10) Pub. No.: US 2026/0005971 A1
(43) Pub. Date: Jan. 1, 2026

(54) TRANSMISSION DEVICE, RECEPTION DEVICE, AND TRANSMISSION/RECEPTION SYSTEM

(71) Applicant: SONY GROUP CORPORATION, TOKYO (JP)

(72) Inventors: KAZUAKI TOBA, TOKYO (JP); HIROSHI MORITA, TOKYO (JP); MASANARI YAMAMOTO, TOKYO (JP); KAZUMOTO KONDO, TOKYO (JP); KAZUO YAMAMOTO, TOKYO (JP)

(21) Appl. No.: 18/857,521

(22) PCT Filed: Mar. 3, 2023
(86) PCT No.: PCT/JP2023/007978

§ 371 Date: Jul. 7, 2025

(30) Foreign Application Priority Data
Apr. 25, 2022 (JP) 2022-071287

(51) Int. Cl. H04L 47/2416; H04N 7/01; H04N 7/10; H04N 7/22

(52) U.S. Cl. CPC H04L 47/2416; H04N 7/0127; H04N 7/10; H04N 7/22

(57) ABSTRACT

To enable continuous video reproduction on a reception side with a minimum delay in a case where baseband video data is transmitted via a network.

A transmission/reception system includes a transmission device and a reception device connected via a network. By the transmission device, baseband video data is transmitted to the reception device via the network, and a transmission speed of the baseband video data is controlled on the basis of a transmission speed change request received from the reception device via the network. By the reception device, the baseband video data is received from the transmission device via the network, and the transmission speed change request is transmitted to the transmission device via the network on the basis of a buffer amount of the baseband video data.

### TECHNICAL FIELD

The present technology relates to a transmission device, a reception device, and a transmission/reception system, and more particularly to a transmission device and the like that transmit baseband video data via a network that is an unstable path.

### BACKGROUND ART

High-definition multimedia interface (HDMI) is the most popular wired interface standard for transmitting baseband video data to a display such as a television. Note that “HDMI” is a registered trademark. This HDMI is assumed to be directly connected by a cable, and there is a possibility that a defect such as image disturbance or a black image occurs when a state in which data is interrupted in an intermediate path, that is, so-called jitter fluctuation occurs.

To avoid an influence of the jitter fluctuation that occurs in the intermediate path, for example, it is conceivable to provide a buffer in the display on a reception side, temporarily accumulate transmitted data in the buffer, and then output the data to ensure continuous video reproduction. However, in this case, it is necessary to increase a buffer capacity in a case where the jitter fluctuation that occurs in the intermediate path is large, and the buffer is short-circuited in a case where transmission is not performed at a constant rate on average due to delays.

In the latest HDMI standard (HDMI ver. 2.1), transmission speed control based on a request from the reception side is only for audio transmission, and video transmission is not defined.

A technique capable of performing continuous video reproduction on a reception side by buffering data is proposed in, for example, Patent Document 1. However, this technique performs a sufficient amount of data buffering in a time unit, and cannot realize real-time transmission and cope with jitter fluctuation in a network of baseband digital video data sensitive to delay time.

### CITATION LIST

### Patent Document

Patent Document 1: Japanese Patent Application Laid-Open No. 2015-065486

### SUMMARY OF THE INVENTION

### Problems to be Solved by the Invention

An object of the present technology is to enable continuous video reproduction on a reception side with a minimum delay in a case where baseband video data is transmitted via a network.

### Solutions to Problems

A concept of the present technology resides in
a transmission device configured to:
transmit baseband video data to an external device through a network; and
control a transmission speed of the baseband video data on the basis of a transmission speed change request received from the external device via the network.

In the present technology, the baseband video data is transmitted to the external device via the network. For example, the baseband video data may be baseband video data corresponding to a predetermined wired interface. In this case, for example, the predetermined wired interface may be an HDMI or a DisplayPort. Furthermore, for example, the network may be an optical communication network.

A transmission speed of the baseband video data is controlled on the basis of a transmission speed change request received from the external device via the network. For example, the transmission speed of the baseband video data may be controlled by changing a frame rate.

For example, a first communication unit configured to communicate with the external device via the network may be included, the first communication unit may transmit the baseband video data to the external device via the network and receive the transmission speed change request from the external device via the network; and a control unit configured to control the transmission speed of the baseband video data on the basis of the transmission speed change request received by the first communication unit may be further included.

In this case, for example, a second communication unit configured to perform communication with a video device that outputs the baseband video data may be further included, and the second communication unit may be configured to receive the baseband video data from the video device, and transmit a control signal for controlling the transmission speed of the baseband video data, for example, the transmission speed change request output from the control unit to the video device. Here, the baseband video data may be baseband video data corresponding to a predetermined wired interface, and the second communication unit may be connected to the video device by a cable corresponding to the predetermined wired interface.

Furthermore, in this case, for example, the baseband video data may be baseband video data corresponding to a predetermined wired interface, a format conversion unit configured to change the baseband video data from a format corresponding to the predetermined wired interface to a format corresponding to the network may be further included, and the first communication unit may transmit the format-converted baseband video data to the external device via the network.

As described above, in the present technology, the transmission speed of the baseband video data to be transmitted to the external device via the network is controlled on the basis of the transmission speed change request received from the external device via the network. A reception side can suppress short-circuit of a buffer that temporarily stores the baseband video data even if a capacity of the buffer is small in order to avoid an influence of jitter fluctuation that occurs in the network, and continuous video reproduction on the reception side can be performed with a minimum delay.

Furthermore, another concept of the present technology resides in
a reception device configured to:
receive baseband video data from an external device via a network; and
transmit a transmission speed change request to the external device via the network on the basis of a buffer amount of the baseband video data.

In the present technology, the baseband video data is received from the external device via the network. For example, the baseband video data may be baseband video data corresponding to a predetermined wired interface. In this case, for example, the predetermined wired interface may be an HDMI or a DisplayPort. Furthermore, for example, the network may be an optical communication network.

The transmission speed change request is transmitted to the external device through the network on the basis of the buffer amount of the baseband video data. For example, the transmission speed change request may be information for requesting a change in a frame rate of the baseband video data.

For example, a first communication unit configured to communicate with the external device via the network may be included, the first communication unit may be configured to receive the baseband video data from the external device via the network and transmit the transmission speed change request to the external device via the network; and a control unit configured to generate the transmission speed change request on the basis of the buffer amount of the baseband video data received by the first communication unit may be further included.

In this case, for example, a second communication unit configured to communicate with a video device that processes the baseband video data received by the first communication unit may be further included, and the second communication unit may be configured to transmit the baseband video data received by the first communication unit to the display device. Here, for example, the baseband video data may be baseband video data corresponding to a predetermined wired interface, and the second communication unit may be connected to the display device by a cable corresponding to the predetermined wired interface.

Furthermore, in this case, for example, the baseband video data received by the first communication unit may be baseband video data in a format corresponding to the network, and a format conversion unit configured to convert the baseband video data received by the first communication unit from the format corresponding to the network into a format corresponding to a predetermined wired interface may be further included.

As described above, in the present technology, the transmission speed change request is transmitted to the external device via the network on the basis of the buffer amount of the baseband video data received from the external device via the network, and it is possible to suppress short-circuit of a buffer that temporarily stores the baseband video data even if the capacity of the buffer is small in order to avoid an influence of jitter fluctuation that occurs in the network, and it is possible to perform continuous video reproduction with a minimum delay.

Furthermore, another concept of the present technology resides in
a transmission/reception system in which a transmission device and a reception device are connected via a network, in which
the transmission device
transmits baseband video data to the reception device via the network, and
controls a transmission speed of the baseband video data on the basis of a transmission speed change request received from the reception device via the network, and
the reception device
receives the baseband video data from the transmission device via the network, and
transmits a transmission speed change request to the transmission device via the network on the basis of a buffer amount of the baseband video data.

The present technology relates to a transmission/reception system in which a transmission device and a reception device are connected via a network. By the transmission device, baseband video data is transmitted to the reception device via the network, and a transmission speed of the baseband video data is controlled on the basis of a transmission speed change request received from the reception device via the network. By the reception device, the baseband video data is received from the transmission device via the network, and the transmission speed change request is transmitted to the transmission device via the network on the basis of a buffer amount of the baseband video data. For example, the baseband video data may be baseband video data corresponding to an HDMI or a DisplayPort, and the network may be an optical communication network.

As described above, in the present technology, in the reception device, the transmission speed change request is transmitted to the transmission device via the network on the basis of the buffer amount of the baseband video data received from the transmission device via the network, and in the transmission device, the transmission speed of the baseband video data to be transmitted to the reception device via the network is controlled on the basis of the transmission speed change request received from the reception device via the network. The reception side can suppress short-circuit of a buffer that temporarily stores the baseband video data even if the capacity of the buffer is small in order to avoid an influence of jitter fluctuation that occurs in the network, and continuous video reproduction on the reception side can be performed with a minimum delay.

### BRIEF DESCRIPTION OF DRAWINGS

FIG. 1 is a diagram illustrating a configuration example of an HDMI transmission/reception system.

FIG. 2 is a diagram illustrating a configuration example of a transmission/reception system as an embodiment.

FIG. 3 is a diagram illustrating a configuration example of a source box.

FIG. 4 is a diagram illustrating a configuration example of a sink box.

FIG. 5 is a sequence diagram for describing an example of an operation of the transmission/reception system.

FIG. 6 is a diagram illustrating an example of a video transmission flow control command and an audio transmission flow control command.

FIG. 7 is a message flow diagram of a CEC command (video transmission flow control command).

### MODE FOR CARRYING OUT THE INVENTION

Hereinafter, a mode for carrying out the invention (hereinafter referred to as an “embodiment”) will be described. Note that description will be given in the following order.
1. Embodiment
2. Modification

### 1. Embodiment

### Description of Related Technology

In recent years, network traffic has been steadily increasing, and power consumption of devices associated with the network traffic has also become a social problem. In order to solve the problem, realization of a large-capacity, low-delay, and low-power consumption network infrastructure by providing an end-to-end path and providing protocol-free transmission using optical communication is discussed and considered in the industry.

Furthermore, an HDMI is the most popular wired digital video transmission method, and is mounted on all displays and used for connection with various devices. In particular, in recent years, high-band transmission of the latest standard is used in high-frame video transmission between a gaming PC/game console and a gaming monitor because of superiority of low latency due to baseband video data. Moreover, in recent game environments, there are many examples of being entertained via a server on a cloud via the Internet. Here, in a case of so-called e-sports, it is required not to impair immediacy with respect to a player operation as much as possible, and delay in network communication is a problem.

In such a situation, by directly communicating the HDMI baseband video data to the end-to-end high-band and low-delay optical communication network, not only packet switching and protocol overheads are eliminated, but also compression/decompression processing in transmission and reception is unnecessary, and it is expected that an ultra-low delay communication environment required for e-sports will be realized in the future.

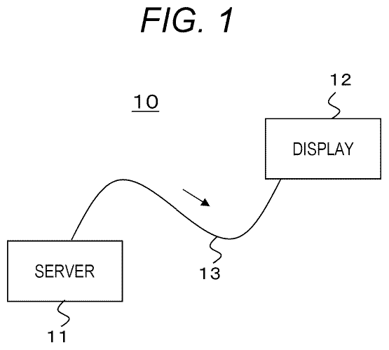

FIG. 1 illustrates a configuration example of an HDMI transmission/reception system 10. In this example, a server 11 as a source device and a display 12 as a sink device are connected by an HDMI cable 13. The HDMI is a standard for transmitting baseband video data in peer-to-peer (P2P) through a cable in synchronization with a pixel clock.

Therefore, the server 11 always outputs the baseband video data with clock jitter within a range defined by the standard without interruption, and transmits the baseband video data to the display 12 as it is. As a result, video display can be performed on the display 12 with a minimum buffer for data.

However, in the case of transmission of the HDMI baseband video data via the network, there is a possibility that an error rate is reduced due to environmental factors or a failure, a route change for increasing path use efficiency, or the like, is performed, for example, during data transmission in a network section. Furthermore, there is a possibility that jitter defined in the HDMI standard cannot be satisfied, such as occurrence of processing queuing in a switch or the like in the intermediate path. When the data is transmitted with specified or more jitter, the baseband video data cannot be received on the reception side in good timing, and a defect such as image disturbance or a black image occurs.

The jitter fluctuation on the network occurs due to data stagnation in the buffer or the like on the intermediate path, only in a direction in which transmission is delayed. Therefore, even if the reception side has a certain amount of buffer, the buffer will be short-circuited if nothing is done.

In the present technology, the reception side requests a transmission side to perform higher-speed transmission while observing the buffer amount, and the transmission side controls the buffer amount to be constant by advancing data accordingly in order to cope with the jitter fluctuation caused by the data stagnation on the network.

As a result, even if the capacity of the buffer that temporarily stores the baseband video data is reduced in order to avoid the influence of the jitter fluctuation that occurs in the network, it is possible to suppress short-circuit of the buffer, and to perform continuous video reproduction with a minimum delay.

### Configuration Example of Transmission/Reception System

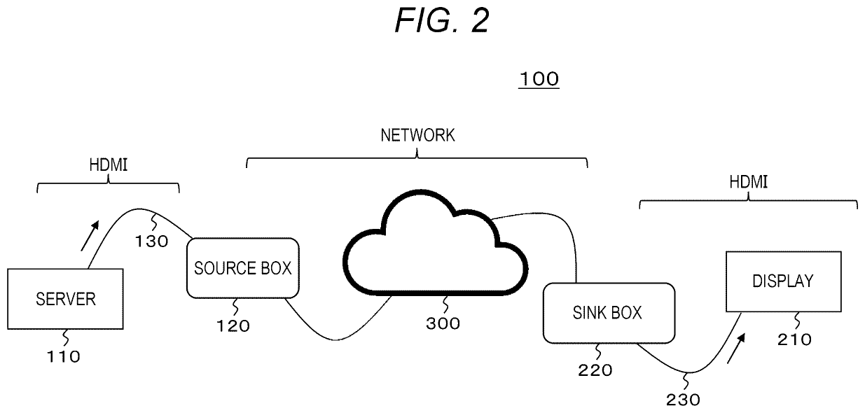

FIG. 2 illustrates a configuration example of a transmission/reception system 100 as an embodiment. The transmission/reception system 100 includes a server (game server) 110 as a video transmission device, a source box 120, a display 210 as an HDMI sink device, and a sink box 220, similarly to a video reproduction device, a game device, or the like as an HDMI source device.

For example, the server 110 exists in a data center and is connected to the source box 120 similarly existing in the data center via the HDMI cable 130. Here, the server 110 constitutes an electronic device that outputs the baseband video data. Furthermore, the display 210 exists at home of a game player (user), for example, and is connected to the sink box 220 similarly existing at the home of the game player via the HDMI cable 230. Here, the display 210 constitutes an electronic device that processes the baseband video data. Then, the source box 120 and the sink box 220 are connected via a network, here, an optical communication network 300.

The server 110 transmits the baseband video data to the source box 120 via the HDMI cable 130. The source box 120 converts the baseband video data transmitted from the server 110 via the HDMI cable 130 from a format corresponding to the HDMI into a format corresponding to the optical communication network 300, further converts an electrical signal into an optical signal, and transmits the optical signal to the sink box 220 via the optical communication network 300.

The sink box 220 converts the baseband video data transmitted from the source box 120 via the optical communication network 300 from an optical signal to an electrical signal, further converts the baseband video data from the format corresponding to the optical communication network 300 to the format corresponding to the HDMI, and temporarily stores the baseband video data in a buffer, that is, buffers the baseband video data. Then, the sink box 220 reads the baseband video data accumulated in the buffer, and transmits the baseband video data to the display 210 via the HDMI cable 230. Thereby, a video based on the baseband video data output from the server 110 is displayed on the display 210.

Furthermore, the sink box 220 monitors the buffer amount, and transmits a transmission speed change request from normal transmission to high-speed transmission, here, to double-speed transmission, that is, a double-speed transmission request to the source box 120 via the network 300 in a case where the buffer amount is smaller than a small-side threshold, that is, a short threshold due to the influence of the jitter fluctuation that occurs in the optical communication network 300, for example. The source box 120 transmits the double-speed transmission request to the server 110 by, for example, a CEC command.

In response to the double-speed transmission request, the server 110 switches to a double-speed frame rate transmission mode by, for example, a variable refresh rate (VRR) function, transmits the baseband video data in the mode to the source box 120 via the HDMI cable 130, and further transmits the baseband video data from the source box 120 to the sink box 220 via the optical communication network 300. Thereby, the buffer amount in the sink box 220 increases.

Thereafter, the sink box 220 monitors the buffer amount, and transmits the transmission speed change request from the double-speed transmission to the normal transmission, that is, to a normal transmission request to the source box 120 via the network 300 in a case where the buffer amount increases and becomes larger than a larger-side threshold, that is, an enough threshold. The source box 120 transmits the normal transmission request to the server 110 by, for example, a CEC command.

In response to the normal transmission request, the server 110 switches to a normal transmission mode by turning off the variable refresh rate (VRR) function, for example, transmits the baseband video data in the mode to the source box 120 via the HDMI cable 130, and further transmits the baseband video data from the source box 120 to the sink box 220 via the optical communication network 300. Thereby, the increase in the buffer amount in the sink box 220 stops.

By controlling the buffer amount in the sink box 220 in this manner, it is possible to suppress the short circuit of the buffer even if the capacity of the buffer in the sink box 220 is reduced, and to perform continuous video reproduction with a minimum delay.

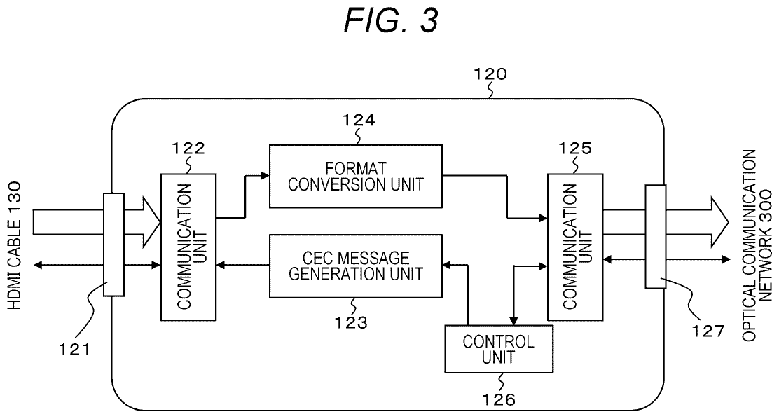

FIG. 3 illustrates a configuration example of the source box 120. The source box 120 includes an HDMI connector 121, a communication unit 122, a CEC message generation unit 123, a format conversion unit 124, a communication unit 125, a control unit 126, and a network connector 127.

The baseband video data in the HDMI format input from the HDMI connector 121 is received by the communication unit 122 and transmitted to the format conversion unit 124. The format conversion unit 124 performs processing such as framing and header addition for the baseband video data in the HDMI format, and converts the baseband video data into baseband video data in the format corresponding to the optical communication network 300. Then, the baseband video data in the format corresponding to the optical communication network 300 is transmitted from the communication unit 125 to the sink box 220 via the network connector 127 and the optical communication network 300.

Furthermore, the transmission speed change request (double-speed transmission request or normal transmission request) input from the network connector 127 is received by the communication unit 125 and transmitted to the control unit 126. The control unit 126 interprets content of the transmission speed change request, and controls the CEC message generation unit 123 to generate a CEC message corresponding to the transmission speed change request. The CEC message is transmitted from the communication unit 122 to the server 110 via the HDMI connector 121 and the HDMI cable 130. Note that, as a CEC message in this case, it is also conceivable to define and use a vendor-unique CEC command that can be understood by the server 110.

Note that, although not illustrated, the source box 120 may be configured to transmit, instead of transmitting the CEC message corresponding to the transmission speed change request (double-speed transmission request or normal transmission request) to the server 110, for example, an SCDC read request for requesting to read a storage area in which the transmission speed change request (double-speed transmission request or normal transmission request) of an SCDC register included in the source box is written. In this case, the server 110 recognizes the transmission speed change request (double-speed transmission request or normal transmission request) by reading the storage area in which the transmission speed change request (double-speed transmission request or normal transmission request) of the SCDC register is written through a DDC line.

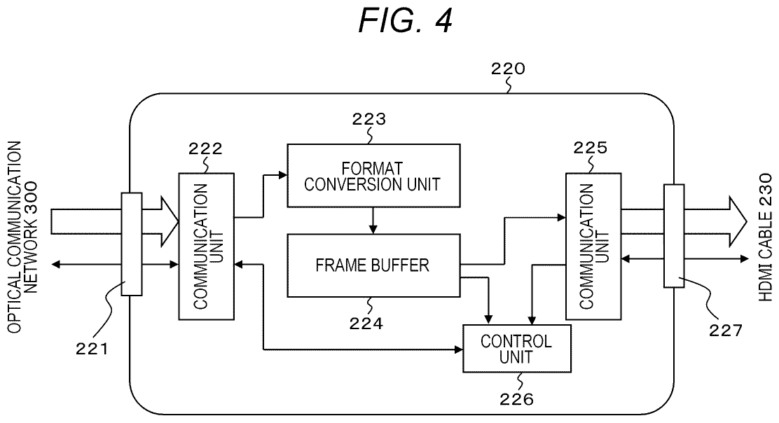

FIG. 4 illustrates a configuration example of the sink box 220. The sink box 220 includes a network connector 221, a communication unit 222, a format conversion unit 223, a frame buffer 224, a communication unit 225, a control unit 226, and an HDMI connector 227.

The baseband video data in the format corresponding to the optical communication network 300 input from the network connector 221 is received by the communication unit 222 and transmitted to the format conversion unit 223. The format conversion unit 223 converts the baseband video data in the format corresponding to the optical communication network 300 into the baseband video data in the HDMI format.

The baseband video data in the HDMI format is temporarily accumulated in the frame buffer 224, that is, buffered. Then, the baseband video data in the HDMI format is read from the frame buffer 224 and transmitted from the communication unit 225 to the display 210 via the HDMI connector 227 and the HDMI cable 230.

Furthermore, the communication unit 222 acquires information of video timing such as a frame rate or a pixel clock from an info frame (InfoFrame) simultaneously transmitted with the baseband video data in the HDMI format, and is transmitted to the control unit 226. Then, the control unit 226 monitors the buffer amount in the frame buffer 224 on the basis of the information of video timing, and performs flow control so that the buffer amount falls within a predetermined range.

In this case, a buffer delay is suppressed to the minimum (one frame) in consideration of a delay of mode switching by the flow control. As a result, in a network environment in which a delay by a communication path is sufficiently small, stable video transmission is realized only by adding the minimum buffer delay (one frame).

In the control unit 226, the buffer amount is monitored in units of pixel clocks or lines, and the transmission speed change request (double-speed transmission request or normal transmission request) is generated in the flow control. In this case, for example, when the buffer amount becomes smaller than the small-side threshold, that is, the short threshold due to the influence of the jitter fluctuation generated in the optical communication network 300, the double-speed transmission request that is the transmission speed change request from the normal transmission to the double-speed transmission is generated. Furthermore, after that, when the buffer amount increases and becomes larger than the larger-side threshold, that is, the enough threshold, the normal transmission request that is the transmission speed change request from the double-speed transmission to the normal transmission is generated.

The transmission speed change request (double-speed transmission request or normal transmission request) generated by the control unit 226 is transmitted from the communication unit 222 to the source box 120 via the network connector 221 and the optical communication network 300.

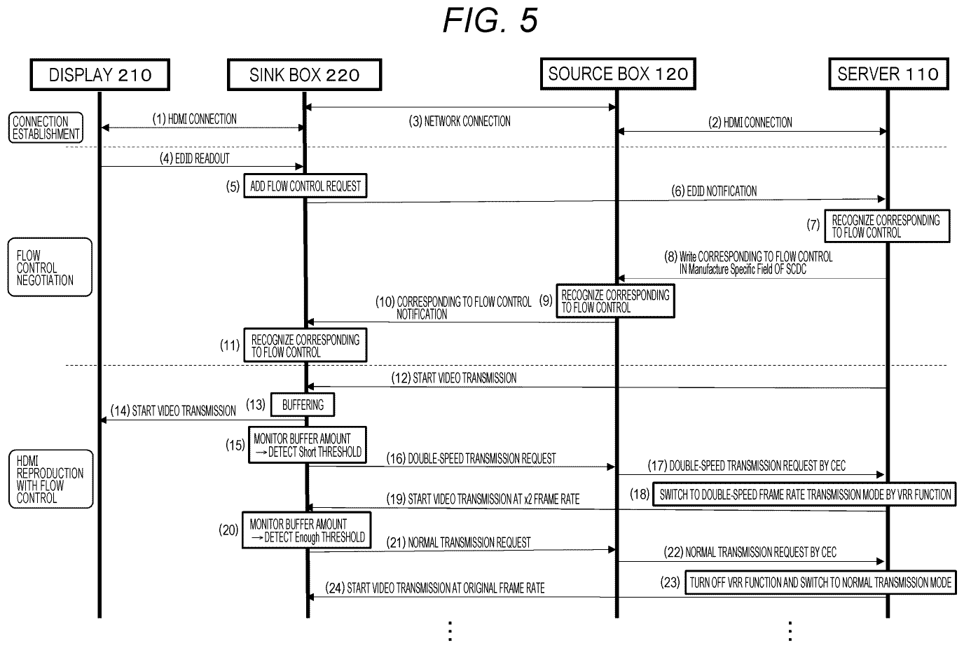

An example of an operation of the transmission/reception system 100 illustrated in FIG. 2 will be described using the sequence diagram of FIG. 5.
(1) The display 210 and the sink box 220 are HDMI-connected by the HDMI cable 230 at the home of the game player (user). (2) Similarly, the server 110 and the source box 120 are HDMI-connected by the HDMI cable 130 in the data center.
(3) Furthermore, a network cable is connected to the other connector of the sink box 220 at the home of the game player (user), and similarly, a network cable is connected to the other connector of the source box 120 in the data center. A network orchestrator recognizes these connections, and mutual communication paths are secured to establish the connection.
(4) After the HDMI connection with the sink box 220 is established, the display 210 notifies the sink box 220 that readout of EDID including its own capability information becomes available with an HPD signal, and the sink box 220 reads the EDID from the display 210 in response to the notification.
(5) Then, the sink box 220 adds, to the EDID read from the display 210, that the present application assumes reproduction via the network with respect to a counter side of the network and that flow control is to be performed, and (6) notifies the server 110 of the EDID via the source box 120.
(7) The server 110 recognizes that a network counter-device is a device corresponding to the flow control, and (8) notifies that the server itself corresponds to the flow control by writing corresponding to the flow control in Manufacture Specific Field of the SCDC register of the source block 120. Note that the server 110 may notify that the server itself corresponds to the flow control by transmitting the CEC message to the source block 120.
(9) The source box 120 recognizes that the server 110 corresponds to the flow control by the notification from the server 110, and (10) notifies the sink box 220 of the fact using a network command. (11) The sink box 220 recognizes that the server 110 corresponds to the flow control according to the notification from the source box 120.
(12) After it is confirmed that the server corresponds to the flow control, the server 110 starts transmission of the baseband video data via the source box 120. (13) The sink box 220 buffers the transmitted baseband video data and (14) outputs the buffered baseband video data to the display 210 via an HDMI terminal. Thereby, reproduction of a video is started.
(15) The sink block 220 monitors the buffer amount and detects whether or not the buffer amount is smaller than the small-side threshold, that is, the short threshold. (16) When detecting that the buffer amount becomes smaller than the short threshold, the sink block 220 transmits the double-speed transmission request to the source block 120.
(17) The source block 120 converts the double-speed transmission request into the CEC message, for example, the vendor-unique CEC command, so that the server 110 can understand the request, and notifies the server 110 of the CEC message. (18) The server 110 switches to the double-speed frame rate transmission mode, for example, with the variable refresh rate (VRR) function, and (19) starts transmission of the baseband video data at a double-speed frame rate via the source box 120.
(20) The sink block 220 monitors the buffer amount and detects whether or not the buffer amount is larger than the large-side threshold, that is, the enough threshold. (21) When detecting that the buffer amount is larger than the enough threshold, the sink block 220 transmits the normal transmission request to the source block 120.
(22) The source block 120 converts the normal transmission request into the CEC message, for example, the vendor-unique CEC command, so that the server 110 can understand the request, and notifies the server 110 of the CEC message. (23) The server 110 turns off the VRR function, switches to the normal transmission mode, and (24) starts transmission of the baseband video data at the original frame rate via the source box 120, that is, returns to transmission of the baseband video data at the original frame rate.

Thereafter, the monitoring of the buffer amount in the sink block 220 is continued, and alternate transmission of the double-speed transmission request and the normal transmission request to the source block 120 is repeated, and the flow control is performed so that the buffer amount falls within a predetermined range.

Note that, in the above description, it has been described that the server 110 returns to the transmission of the baseband video data at the original frame rate according to the instruction from the sink block 220. However, for example, in a case where monitoring is performed in a very fine time unit, a configuration in which the double-speed transmission is performed only for one frame and the server 110 automatically returns is also conceivable.

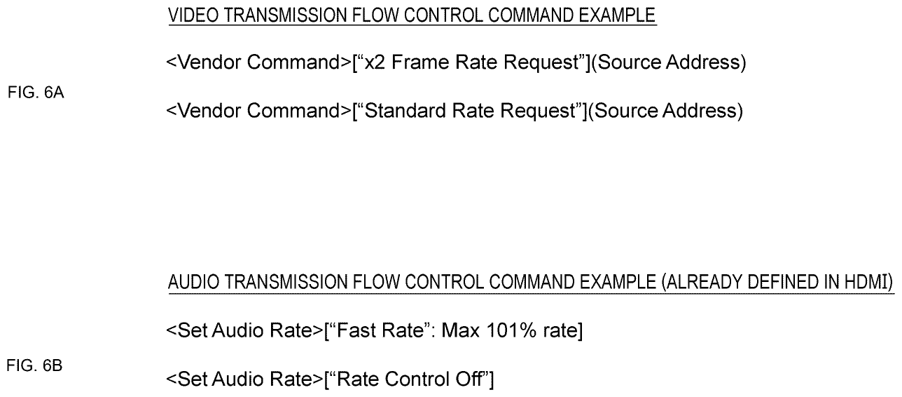

FIG. 6(a) illustrates an example of the vendor-unique CEC commands indicating the double-speed transmission request and the normal transmission request transmitted from the source box 120 to the server 110. Here, “<Vendor Command> [“x2 Frame Rate Request”] (Source Address)” indicates a CEC command of a double-speed transmission request, and “<Vendor Command> [“Standard Rate Request”] (Source Address)” indicates a CEC command indicating a normal transmission request.

Note that the CEC command in the illustrated example has an operand structure designating a source address, but since the CEC command is a CEC command for an active source, it is not always necessary to designate the source address. Furthermore, the CEC message indicating the double-speed transmission request and the normal transmission request transmitted from the source box 120 to the server 110 may be newly defined in the HDMI standard instead of being defined as the vendor-unique CEC command.

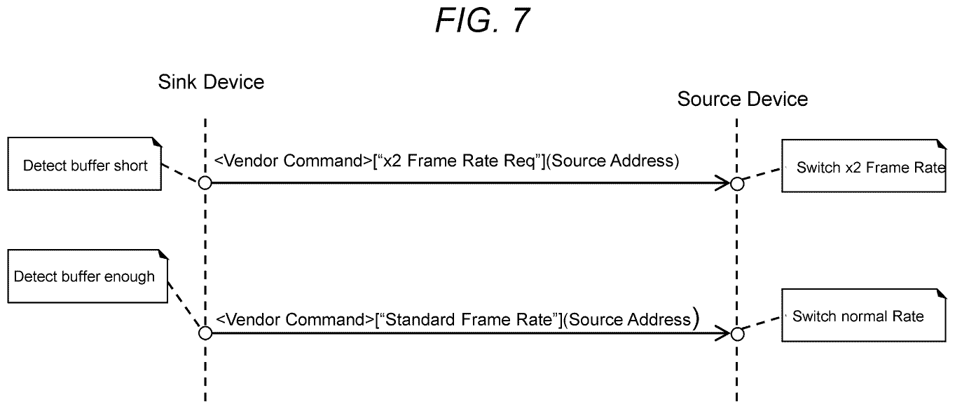

FIG. 7 illustrates a message flow diagram of the CEC commands illustrated in FIG. 6(a). In the above description, the command is transmitted from the source box 120 to the server 110, but is defined as a command issued mainly by the sink device according to the HDMI standard.

As described above, in the transmission/reception system 100 illustrated in FIG. 2, on the reception side, the transmission speed change request (double-speed transmission request or normal transmission request) is transmitted to the transmission side via the optical communication network 300 on the basis of the buffer amount of the baseband video data received from the transmission side via the optical communication network 300, and on the transmission side, the transmission speed of the baseband video data to be transmitted to the reception side via the optical communication network 300 is controlled on the basis of the transmission speed change request received from the reception side via the optical communication network 300. The reception side can suppress short-circuit of the buffer that temporarily stores the baseband video data even if the capacity of the buffer is small in order to avoid the influence of jitter fluctuation that occurs in the network, and continuous video reproduction on the reception side can be performed with a minimum delay.

### 2. Modification

Note that, in the above-described embodiment, an example of the flow control in the case where video data is transmitted via the network has been described, but the same similarly applies to audio transmission. The server side may simultaneously transmit audio belonging to the frame of the video data at the time of transmitting the video data or may perform flow control for audio data as another system.

FIG. 16(b) illustrates an example of the CEC commands that can be used in the flow control of the audio transmission. These are defined in the latest HDMI standard. “<Set Audio Rate> [“Fast Rate”: Max 101% rate]” is a CEC command that requests the high-speed transmission at 101%, and “<Set Audio Rate> [“Rate Control Off”]” is a CEC command that requests stop of the high-speed transmission. By using these CEC commands, it is possible to realize, for the audio transmission, flow control similar to the video transmission.

Furthermore, in the above-described embodiment, the server 110 and the source box 120 are arranged on the transmission side of the baseband video data, and the display 210 and the sink box 220 are arranged on the reception side thereof. Here, a configuration in which the server 110 and the source box 120 on the transmission side are integrated and the display 210 and the sink box 220 on the reception side are integrated is also conceivable.

Furthermore, in the above-described embodiment, an example in which the wired interface is the HDMI has been described. However, the wired interface to which the present technology can be applied is not limited to the HDMI, and may be another wired interface, for example, DisplayPort or the like.

Furthermore, the preferred embodiment of the present disclosure has been described above in detail with reference to the accompanying drawings, but the technical scope of the present disclosure is not limited to such example. It is apparent that a person having ordinary knowledge in the technical field of the present disclosure can devise various changes or modifications within the scope of the technical idea disclosed in the claims, and it will naturally be understood that they also belong to the technical scope of the present disclosure.

Furthermore, the effects described in the present specification are merely exemplary or illustrative, and not restrictive. That is, the technique according to the present disclosure can exhibit other effects apparent to those skilled in the art from the description of this specification, in addition to the above-described effects or instead of the above-described effects.

Furthermore, the present technology can also have the following configurations.
(1) A transmission device configured to:
transmit baseband video data to an external device through a network; and
control a transmission speed of the baseband video data on the basis of a transmission speed change request received from the external device via the network.
(2) The transmission device according to (1) above, in which
the baseband video data is baseband video data corresponding to a predetermined wired interface.
(3) The transmission device according to (2) above, in which
the predetermined wired interface is an HDMI or a DisplayPort.
(4) The transmission device according to any one of (1) to (3) above, in which
the network is an optical communication network.
(5) The transmission device according any one of (1) to (4) above, in which
the transmission speed of the baseband video data is controlled by changing a frame rate.
(6) The transmission device according to any one of (1) to (5) above, further including:
a first communication unit configured to communicate with the external device via the network,
the first communication unit being configured to transmit the baseband video data to the external device via the network and receives the transmission speed change request from the external device via the network; and
a control unit configured to control the transmission speed of the baseband video data on the basis of the transmission speed change request received by the first communication unit.
(7) The transmission device according to (6), further including:
a second communication unit configured to perform communication with a video device that outputs the baseband video data,
the second communication unit being configured to receive the baseband video data from the video device, and transmit a control signal for controlling the transmission speed of the baseband video data output from the control unit to the video device.
(8) The transmission device according to (7) above, in which
the baseband video data is baseband video data corresponding to a predetermined wired interface, and
the second communication unit is connected to the video device by a cable corresponding to the predetermined wired interface.
(9) The transmission device according any one of (6) to (8) above, in which
the baseband video data is baseband video data corresponding to a predetermined wired interface,
a format conversion unit configured to change the baseband video data from a format corresponding to the predetermined wired interface to a format corresponding to the network is further included, and
the first communication unit transmits the format-converted baseband video data to the external device via the network.
(10) A reception device configured to:
receive baseband video data from an external device via a network; and
transmit a transmission speed change request to the external device via the network on the basis of a buffer amount of the baseband video data.
(11) The reception device according to (10) above, in which
the baseband video data is baseband video data corresponding to a predetermined wired interface.
(12) The reception device according to (11) above, in which
the predetermined wired interface is an HDMI or a DisplayPort.
(13) The reception device according any one of (10) to (12) above, in which
the network is an optical communication network.
(14) The reception device according any one of (10) to (13) above, in which
the transmission speed change request is information for requesting a change in a frame rate of the baseband video data.
(15) The reception device according to any one of (10) to (14), further including:
a first communication unit configured to communicate with the external device via the network,
the first communication unit being configured to receive the baseband video data from the external device via the network and transmit the transmission speed change request to the external device via the network; and
a control unit configured to generate the transmission speed change request on the basis of the buffer amount of the baseband video data received by the first communication unit.
(16) The reception device according to (15), further including:
a second communication unit configured to communicate with a display device that processes the baseband video data received by the first communication unit,
the second communication unit being configured to transmit the baseband video data received by the first communication unit to the display device.
(17) The reception device according to (16) above, in which
the baseband video data is baseband video data corresponding to a predetermined wired interface, and
the second communication unit is connected to the display device by a cable corresponding to the predetermined wired interface.
(18) The reception device according any one of (15) to (17) above, in which
the baseband video data received by the first communication unit is baseband video data in a format corresponding to the network, and
a format conversion unit configured to convert the baseband video data received by the first communication unit from the format corresponding to the network into a format corresponding to a predetermined wired interface is further included.
(19) A transmission/reception system in which a transmission device and a reception device are connected via a network, in which
the transmission device
transmits baseband video data to the reception device via the network, and
controls a transmission speed of the baseband video data on the basis of a transmission speed change request received from the reception device via the network, and
the reception device
receives the baseband video data from the transmission device via the network, and
transmits a transmission speed change request to the transmission device via the network on the basis of a buffer amount of the baseband video data.
(20) The transmission/reception system according to (19) above, in which
the baseband video data is baseband video data corresponding to an HDMI or a DisplayPort, and
the network is an optical communication network.

### REFERENCE SIGNS LIST

100 Transmission/reception system
110 Server
120 Source box
121 HDMI connector
122 Communication unit
123 CEC message generation unit
124 Format conversion unit
125 Communication unit
126 Control unit
127 Network connector
130 HDMI cable
210 Display
220 Sink box
221 Network connector
222 Communication unit
223 Format conversion unit
224 Frame buffer
225 Communication unit
226 Control unit
227 HDMI connector
230 HDMI cable
300 Optical communication network

1. A transmission device configured to:
transmit baseband video data to an external device through a network; and
control a transmission speed of the baseband video data on a basis of a transmission speed change request received from the external device via the network.

2. The transmission device according to claim 1, wherein
the baseband video data is baseband video data corresponding to a predetermined wired interface.

3. The transmission device according to claim 2, wherein
the predetermined wired interface is an HDMI or a DisplayPort.

4. The transmission device according to claim 1, wherein
the network is an optical communication network.

5. The transmission device according to claim 1, wherein
the transmission speed of the baseband video data is controlled by changing a frame rate.

6. The transmission device according to claim 1, further comprising:
a first communication unit configured to communicate with the external device via the network,
the first communication unit being configured to transmit the baseband video data to the external device via the network and receives the transmission speed change request from the external device via the network; and
a control unit configured to control the transmission speed of the baseband video data on a basis of the transmission speed change request received by the first communication unit.

7. The transmission device according to claim 6, further comprising:
a second communication unit configured to perform communication with a video device that outputs the baseband video data,
the second communication unit being configured to receive the baseband video data from the video device, and transmit a control signal that controls the transmission speed of the baseband video data output from the control unit to the video device.

8. The transmission device according to claim 7, wherein
the baseband video data is baseband video data corresponding to a predetermined wired interface, and
the second communication unit is connected to the video device by a cable corresponding to the predetermined wired interface.

9. The transmission device according to claim 6, wherein
the baseband video data is baseband video data corresponding to a predetermined wired interface,
a format conversion unit configured to change the baseband video data from a format corresponding to the predetermined wired interface to a format corresponding to the network is further included, and
the first communication unit transmits the format-converted baseband video data to the external device via the network.

10. A reception device configured to:
receive baseband video data from an external device via a network; and
transmit a transmission speed change request to the external device via the network on a basis of a buffer amount of the baseband video data.

11. The reception device according to claim 10, wherein
the baseband video data is baseband video data corresponding to a predetermined wired interface.

12. The reception device according to claim 11, wherein
the predetermined wired interface is an HDMI or a DisplayPort.

13. The reception device according to claim 10, wherein
the network is an optical communication network.

14. The reception device according to claim 10, wherein
the transmission speed change request is information that requests a change in a frame rate of the baseband video data.

15. The reception device according to claim 10, further comprising:
a first communication unit configured to communicate with the external device via the network,
the first communication unit being configured to receive the baseband video data from the external device via the network and transmit the transmission speed change request to the external device via the network; and
a control unit configured to generate the transmission speed change request on a basis of the buffer amount of the baseband video data received by the first communication unit.

16. The reception device according to claim 15, further comprising:
a second communication unit configured to communicate with a display device that processes the baseband video data received by the first communication unit,
the second communication unit being configured to transmit the baseband video data received by the first communication unit to the display device.

17. The reception device according to claim 16, wherein
the baseband video data is baseband video data corresponding to a predetermined wired interface, and
the second communication unit is connected to the display device by a cable corresponding to the predetermined wired interface.

18. The reception device according to claim 15, wherein
the baseband video data received by the first communication unit is baseband video data in a format corresponding to the network, and
a format conversion unit configured to convert the baseband video data received by the first communication unit from the format corresponding to the network into a format corresponding to a predetermined wired interface is further included.

19. A transmission/reception system in which a transmission device and a reception device are connected via a network, wherein
the transmission device
transmits baseband video data to the reception device via the network, and
controls a transmission speed of the baseband video data on a basis of a transmission speed change request received from the reception device via the network, and
the reception device
receives the baseband video data from the transmission device via the network, and
transmits a transmission speed change request to the transmission device via the network on a basis of a buffer amount of the baseband video data.

20. The transmission/reception system according to claim 19, wherein
the baseband video data is baseband video data corresponding to an HDMI or a DisplayPort, and
the network is an optical communication network.
